(19) United States
(12) Patent Application Publication
(10) Pub. No.: US 2021/0025198 A1
(43) Pub. Date: Jan. 28, 2021

(54) Improved flexible digitally printable and tamperproof suitcase locker

(71) Applicant: SL PATENT B.V., Aarlanderveen (NL)

(72) Inventors: Meeuwis Adriaan Johan DE WEERD, Zandvoort (NL); Bjorn VAN DEN BOSCH, Aarlanderveen (NL)

(73) Assignee: SL PATENT B.V., Aarlanderveen (NL)

(21) Appl. No.: 17/041,839

(22) PCT Filed: Mar. 26, 2019
(86) PCT No.: PCT/NL2019/050187

§ 371 Date: Sep. 25, 2020

(30) Foreign Application Priority Data
Mar. 26, 2018 (NL) 2020662

(51) Int. Cl. E05B 65/52; A45C 13/18

(52) U.S. Cl. CPC E05B 65/52; A45C 13/18

(57) ABSTRACT

The present invention is in the field of a flexible tamperproof suitcase locker, which is made of a flexible foil, a method of applying said suitcase locker, and various further applications thereof. Typically the present suitcase locker is of a one size fits all dimension, hence applicable to each and every suitcase. Further the foil typically has a clearly recognizable and differentiating print or the like.

### FIELD OF THE INVENTION

The present invention is in the field of a flexible tamperproof suitcase locker, a method of applying said suitcase locker, and various further applications thereof.

### BACKGROUND OF THE INVENTION

The present invention is in the field of a flexible tamperproof suitcase locker.

Suitcase may suffer from tampering especially during unattended transport thereof, such as on an airport, in an airplane, in a bus, and on a train. At the one end goods from a suitcase may be stolen, and at the other end goods may be added to a suitcase unwanted, such as illegal goods. Typically suitcase can be locked or provided with a lock. Such a lock is typically inadequate to prevent tampering. More important, tampering can not be noted.

In example of a locker is found in U.S. Pat. No. 8,388,025 B2. Therein a strip for tamper evidencing has a first layer and one or more reinforcing layers. An adhesive is provided on a first portion of the strip to selectively adhere the first portion of the strip onto the first layer of a second portion of the strip, wherein the first layer is such that removal or attempted removal of the first portion of the strip from the second portion of the strip will be evidenced by the first layer. The reinforcing material is arranged such that portions of it are bonded to each other at a plurality of locations spaced along the length of the strip. The strip is for application on a zip, a zip slider, and a zip tab. It has been found that the strip is not always fail proof, does not always provide tamper evidence, and the strip and especially an identifier may get damaged upon use and as a consequence loosing functionality. In an alternative thereto (U.S. Pat. No. 8,474,584 B2) a buckle type of relatively small strip of reinforced material is provided and therefore has limited applicability.

In an alternative a suitcase can be fully wrapped in a foil, typically a number of times. At for instance airports such wrapping is provided in the form of machines, but wrapping is rather time consuming and lots of foil is used which later needs to be disposed of. Also hard covers or the like may be provided. Typically suitcase lockers are (somewhat) difficult to apply.

In addition suitcase often get lost or need to be relocated at a late instance, leading to e.g. flight delays.

In another aspect it is found difficult to provide prints on a foil or film, especially digital prints. Typically requirements for digital printing do not match those of foils, and are in fact mostly contradictory. For instance, for digital printing a UV-curing ink may be used, whereas UV typically degrades polymers of which foils are typically formed. A similar problem arise with a surface of typical foils, which is found unsuited to provide good printing properties, such as for providing a name or tag to the suitcase. In addition a melting point and glass transition temperature of most films is too low.

Various documents recite plastic materials which are for various reasons unsuited for the present purpose.

U.S. Pat. No. 3,752,312 A recites a baggage-handling system in which luggage of any size or shape is wrapped with an encircling belt made of a heat-shrinkable plastic material at a baggage-tagging station designed for this purpose. The baggage is then put on a conveyor which carries it through an oven to shrink the plastic so that the tag is securely attached to the luggage, and the belt lies flat against the surface of the luggage. Destination-identifying indicia printed on the plastic belt are then read by an optical scanner which is positioned alongside the baggage conveyor.

EP 2 431 962 A1 recites a multi-layer loop tag having the form of an elongated strip comprising a release layer, a self-adhesive layer, wherein the release layer is attached to the self-adhesive layer; a laminate is formed. It is a goal to provide a rather stiff tag that can not be wind up around a roller in a printer. Thereto the above multi-layer tag with at least two webs is provided. Some examples of such webs are given. These webs may have a release layer, that is are releasable attacked. Various internet sites report of self-adhesives.

US 2004/206431 A1 relates to a checked luggage security sleeve system for airlines provides a cover or sleeve of transparent plastic sheeting having a closed end and an open end to receive a piece of luggage. The cover identifies the airline and reaches partially around the base of the piece of luggage. Security tape identifying the airline seals the free end of the sleeve under the base of the piece of luggage near the center, exposing wheels at an end or spaced along a side of the base of the piece of luggage. The tape cannot be removed without leaving evidence of tampering. Said tape can not be printed digitally and can not be attached to e.g. a suitcase without a risk that the incisions for a handle are ruptured. GB 2 386 061 A relates to a functionally very different approach, namely a single-use disposable envelope for containing a travel bag or suitcase comprising a formed or welded plastics sheet with a sealable slot or opening extending across one end of the bag. Said envelope is not firmly attached and fixed around a suitcase and is made of a heavy grade PE which is not printable and otherwise not suited. US 2007/193667 A1 recites a protection for an article of luggage, but other than that has not much to do with the present invention. U.S. Pat. No. 6,222,452 B1 recites an electronic identification tag made up of at least one cover strip and a carrier strip having an antenna and transponder mounted thereon, and an adhesive to secure the strips together such that the antenna is interposed between the strips, the transponder being pre-programmed to generate a signal having a unique code correlated with indicia on the tag to identify a passenger or luggage. US 2008/088125 A1 recites a disposable strip of non-elastic, tear resistant luggage wrap material to extend around the outer periphery of a piece of luggage to adhesively secure to itself. Indicia may be preprinted thereon. The teachings of the above documents seems difficult to combined as they are considered incompatible in various aspects; possibly a combination could solve a single problem, but it would introduce at least one further problem.

In addition application of a foil or fil around a suitcase is somewhat cumbersome. It is difficult to wrap the foil around a suitcase without forming bubbles, bulging, or wrinkles. In addition a handle or grip of a suitcase is in the way when wrapping and an opening provided for the handle is found to be a relatively weak area.

The present invention therefore relates to an improved suitcase locker, which solves one or more of the above problems and drawbacks of the prior art, providing reliable results, without jeopardizing functionality and advantages.

### SUMMARY OF THE INVENTION

The present invention relates to a flexible and tamperproof suitcase locker 100 according to claim 1. Therein a digitally printable foil 10 is provided which is also tamperproof, i.e. interference or meddling or changes to the present foil, such as when a person tries to remove the foil or to open the suitcase, is immediately visible as the foil is irreversibly damaged, such as by deformation, and comprises an adhesive providing a string bond upon application. The term “foil is to be understood in combination with the materials the foil comprises, i.e. a polymer and an inorganic filler. The term “foil” may therefore also be interpreted as “film”. The term “tamperproof” may also include or refer to “tamper evident”, in line with the above. It has been found very difficult to provide a foil which can be printed in a digital way, such as by using an inkjet printer or the like; the prior art cited does not provide such foils. For instance U.S. Pat. No. 3,752,312 A recites a belt that is shrunk; as a consequence any information on the shrunk parts is not readable anymore, contrary to the information on the present foil. Such is especially in view of providing personal details of a user in a digital manner, such as name, address, flight details, bar codes, two-dimensional codes such as QR-codes, etc. These details are often provided at the port of departure, and not earlier. Therefore a digitally printable foil is required to allow provision of a suitcase locker with printed information, which can be applied unshrunk. In addition it would be an advantage if a clearly recognizable and differentiating print or the like could be provided; as such an owner could recognize his/her suitcase almost immediately when e.g. the suitcase is amongst other similar suitcases, such as on a conveyer belt in an airport. Such a recognizable print could help limiting time needed and therewith reducing risks such as of acts of terrorism or illegal activities. In order to be digitally printable, or likewise having properties comparable to paper and therewith making handwriting possible as well, the present foil is provided with a relatively large amount of inorganic filler, such as 10-50 wt. %, preferably 12-40 wt. %, more preferably 15-30 wt. %, such as 17-25 wt. %. Typically the present foil may be treated before printing, such as by an oxidative treatment, such as with ozone, a peroxide, or the like. This further treatment has been found to improve properties of a foils on a microscopic scale, such that pores have better and more homogeneous properties. Such is found to provide good printing properties in terms of adherence for typical inkjets to the surface of the foil; in addition the filler is found not to disturb the curing process of a typical ink significantly. Upon curing a temperature of the ink is typically raised to 30-70° C. locally; therefore the foil should be capable of withstanding increased temperatures and should not deform significantly. In addition curing is typically performed by using UV-light and therefore a suitable polymer should be selected for such applications which does not significantly degrade or partly degrades upon application of said UV-light. When typical printing is used an initial foil is printed at relatively high speed, which printing poses restrictions to a foil material in various aspects as well. With digital printing high resolution prints can be provided, which prints could be varied from foil segment to foil segment.

In order to provide a tamperproof locker the foil is typically of a width large enough to span a width of a suitcase substantially, is long enough to wrap a suitcase, and thick enough to be tamperproof; preferably a one size fits all foil is provided. The foil therefore has a width of 15-50 cm, preferably 20-45 cm, more preferably 20-40 cm, such as 20-35 cm, e.g. 30-33 cm, a length of 150-200 cm, preferably 160-195 cm, such as 170-190 cm, e.g. 175-180 cm, and a thickness of 40-200 μm, preferably 50-150 μm, more preferably 60-120 μm, such as 80-100 μm. The foil is preferably as thin as possible, and should be strong enough to be tamperproof. The present foil typically does not require a further reinforcing layer or material as the foil is strong enough in itself. The present foil typically is made of a single layer. In order to apply the foil in such a way that it can not be removed without deforming the foil noticeably, an adhesive 20 is provide at at least one longitudinal end thereof (e.g. “top” or “bottom” when placed in portrait mode/upright). Typically the adhesive is provided after digitally printing the foil. The adhesive is used to adhere a top end of the foil to a bottom end, after wrapping the foil around a suitcase, wherein adherence typically takes place by adhering a backside of the foil to a front side thereof. In view of forces that may be applied to the foil one end of the foil may be in a triangular shape, in order to increase a surface are comprising adhesive. The bond provided by adhering is so strong (e.g. a direct adhesive strength of >25 N/cm², preferably >50 N/cm², such as >100 N/cm², an adhesive strength after 10 minutes after application of >30 N/cm², preferably >50 N/cm², such as >60 N/cm², and an adhesive strength after 60 minutes after application of >40 N/cm², preferably >60 N/cm², such as >80 N/cm² (ISO 4587), and/or an adhesive strength of >20 N/cm, such as >40 N/cm (ISO 8510-2:2006); typically adhesives provide a strength of <1 N/cm, whereas some adhesives may have a strength of up to 5-10 N/cm. that effectively it can not be broken, at least not under typical conditions, and certainly not without noticeably deforming the foil. The present adhesive can preferably not be removed by cooling, such as to a low temperature, such as to −50° C. or lower, and then removing the frozen adhesive. It is noted that finding a suitable adhesive for the present foil has been difficult. In addition the foil can be wrapped so tightly around the suitcase that it can not be slid of; in this sense the foil may be regarded as being united with the suitcase. It is noted that the foil also deforms when someone tries to remove the seal by applying too much heat. Thereto the foil is also of a sufficiently flexible material. Therefore if an attempt is made to tamper the suitcase or removing the foil such can immediately be seen.

The present foil can be used as such, so e.g. no laminate is required. The present foil may be non-woven and typically is non-woven. The present foil may have no reinforcements, such as fibers, and typically is not reinforced. The present foil may be non-structured and typically is non-structured. The present foil may not be porous and typically is non-porous.

The present invention relates in many aspects to the invention of co-pending applications PCT/NL2018/050016 and NL2018149. A further improvement in view thereof is the present opening. Thereto the foil comprises at least one opening (50) comprising least three incision, a first horizontal incision (51), adjacent to either end of the horizontal incision two substantially circular incisions (52), or any similar curved incision, providing space for a suitcase handle to pass through the opening, such as an oval incision, an ellipsoidal, a multigonal, and combinations thereof, wherein the two substantially circular incisions comprise, respectively at an left and right end of the three incisions, an inwardly extending indentation (54), wherein the indentation has at either side two curved sections (55), which curved sections have a smaller radius than the substantially circular incisions. The indentation may be provided by die cutting or punching through. It has been found that the foil can be applied in a very firm and easy manner around a suitcase; no bulging or wrinkling occurs and the foil can be applied in one go. In addition tearing of the foil, for instance at edges thereof is prevented. A suitcase handle may also relate to an extendable handle. As such the foil can be wrapped even more firmly around a suitcase.

In a second aspect the present invention relates to a method of applying the present suitcase locker by wrapping the locker around the suitcase and adhering the two ends to one and another, and optionally scanning the identifier, such as at a distance of 0.1-500 cm (i.e. at a distance when substantially contacting when scanning to a relatively small distance). These steps may be repeated e.g. if more than one suitcase is provided. By using an RFID identifier or the like scanning can be performed. The identifier is typically a unique identifier, such that each and every suitcase c.q. identifier can be determined on an individual basis. As such the suitcase and its owner can be determined in a unique manner. Such may for instance be relevant in order to determine tampering, loss of a suitcase, relocating a suitcase, etc. In addition such a unique identifier may speed up processes such as on an airport when checking in, when processing suitcases, etc. significantly.

The present invention also relates to an opening 50.

Thereby the present invention provides a solution to one or more of the above mentioned problems and drawbacks.

Advantages of the present description are detailed throughout the description.

### DETAILED DESCRIPTION OF THE INVENTION

The present invention relates in a first aspect to a suitcase locker according to claim 1.

In an exemplary embodiment of the present suitcase locker the three incisions may form one combined incision, which is less preferred in view of tearing, but still an option.

In an exemplary embodiment of the present suitcase locker the at least one incision may be intermitted such that the foil is integral (53). Also an intermitted incision may be provided at either end of the horizontal incision, and/or at the left and right end of the circular incisions. As can be seen in FIG. 2c especially a section at the right and left side is intermitted, i.e. not cut (indicated with an arrow). Therewith tearing is prevented and the foil can be wrapped easily around a suitcase.

In an exemplary embodiment of the present suitcase locker may comprise an adhesive strip (60) for securing the foil around a grip. It has been found that user intuitively wrap the foil around a suitcase and adhere the strip to a grip thereof. The strip may comprise a releasable adhesive protection.

In an exemplary embodiment of the present suitcase locker the foil may comprise a wireless identifier 30 attached thereto, such as by adhering or integrating into the foil, wherein the identifier is adapted to provide wireless communication selected form at least one of RF, near field (NF), near infra-red, preferably at least RF and NF. The identifier typically comprises a tag, a reader and a so-called back-end, such as a database. It may operate in tag-emulation or passive mode, an active mode such as a reader, and a so-called peer-to-peer mode such as when communication between two devices. As such the identifier can be scanned wireless, such as by a smart phone, a scanner, etc. The identifier may be a passive identifier, such as comprising a coil and/or capacitor, for receiving power wireless. The identifier typically comprises a transmitter for communicating its identity to an outside world. The wireless communication typically is established over a short distance or upon “direct” contact, such as by placing a scanner on the identifier. A short distance typically relates to no or a few cm up to a few meter, i.e. at close distance, preferably 1 cm-300 cm, more preferably 2 cm-200 cm, even more preferably 5 cm-150 cm, such as 10-50 cm. Therewith the identity of the suitcase as well as of its owner can be established quickly and reliably.

In an example the identifier of the tracking device may comprise a NFC (Near Field Communication) operating at a 13.56 Mhz frequency, ISO/IEC 14443A-3 compliant and NFC Forum Type 2 compatible, and an RFID (Far Field Communication) operating at a 860 to 960 MHz frequency, ISO/IEC 18000-63 compliant, EPC Gen2 V2 compliant-Alteration EAS compliant-Tag Alteration (Core) compliant. An identifier chip may be manufactured with a 96-bit unalterable unique identifier (UID) to ensure full traceability. The same UID number is used by both RF protocols. The identifier may have an extra build-in tamper evident safety feature: An attempt to remove the chip will result in a delamination (disintegration) of the NFC module while the RFID module will remain fully functional.

In an exemplary embodiment of the present suitcase locker the foil may comprise pores and/or comprises pores after treatment, such as an oxidative treatment, such as with ozone, or with a corona treatment, preferably pores in a size range of 100-2500 nm, more preferably 200-1000 nm, such as 300-800 nm. In addition to the present filler the pores are found to provide good properties for applying an ink, such as from an ink jet, to the surface of the present foil.

The present foil can advantageously be characterized by certain parameters, such as the ones mentioned below. These parameters are considered to be well understood by the skilled person.

In an exemplary embodiment of the present suitcase locker the foil may have an ultimate tensile strength (ISO 1184, 25° C. c.q. ISO 527-3) of 5-100 MPa, preferably 7-75 MPa, more preferably 10-50 MPa, such as 20-40 MPa, and/or wherein the foil may have a Young's modulus of <2.5 GPa, preferably <2.0 GPa, more preferably <0.7 GPa, even more preferably <0.5 GPa, and/or wherein the foil may have an elongation at break (ISO 1184) of >50%, preferably >100%, more preferably >250%, even more preferably >500%, such as >750%, and/or wherein the foil may have a density of 1-1.2 g/cm³, preferably 1.05-1.15 g/cm³, such as 1.09-1.11 g/cm³, and/or wherein the foil may have a coefficient of friction (film to film, un-treated side to untreated side; ISO 8295) of 0.2-0.4 (dynamic), preferably 0.25-0.35, such as 0.28-0.32 and 0.3-0.5 (static), preferably 0.35-0.45, such as 0.38-0.42, and/or a water vapor transmission rate (ASTM E-96-00 23° C., 85% RH) of 50-80 g/m² day, such as 60-70 g/m² day, and/or an impact resistance (dart value ISO 7765-2) of >250 gram, preferably >400 gr, such as 450-600 gr, and/or an oxygen transmission rate (ASTM D-3985-95, Measured O₂GTR cc/m²·day) of 100-600, preferably 150-500, such as 200-400. As such the foil provide good tamperproof properties, which may be combined suitably with its excellent printing properties and adhesive properties of the adhesive. The foil in addition may have a paper like appearance and behavior, especially in view of digital printing. The present foil has excellent folding properties, perfect printing applications, a UV light barrier, a very high tensile strength, a high tearing resistance, a high barrier for oxygen and good vapor permeability.

In an exemplary embodiment of the present suitcase locker the foil may be stable under application of a light frequency of 300-400 nm, preferably 350-390 nm, such as 360-380 nm. Such may be relevant when applying a curable ink, such as an ink jet ink, which ink is cured at wavelength that also might degrade a polymer c.q. a foil.

In an exemplary embodiment of the present suitcase locker the foil may have a glass transition temperature of <60° C. (ISO 11357-2:2013), and/or a melt temperature of >70° C. (ISO 3146:2000). Such may be relevant in view of application conditions of an ink such as in an ink jet device.

In an exemplary embodiment of the present suitcase locker the inorganic filler may be selected from calcium oxide, calcium carbonate, clays, preferably silica-alumina clays, silica, talc, chalk, titanium oxide, and combinations thereof. The filler preferably has an average grain size (such as measured by light scattering at 400 nm and 25° C. and a relative humidity of 60% or less) of 100-5000 nm, more preferably 200-2500 nm, such as 500-2000 nm.

In addition the present foil may comprise further additives, such as pigments, dyes, colorants, stabilizers, anti-fouling agents, biocides, fungicides, bactericides, metals, etc.

In an exemplary embodiment of the present suitcase locker the polymer may be selected from polyolefines, such as polypropylene, polyethylene, high density PP and PE, biodegradable polymers, biobased polymers, such as alginate, preferably renewable polymers, and combinations thereof. In an example the polymer is based on ethylene obtained from natural sources, such as sugar cane or corn.

In an exemplary embodiment of the present suitcase locker the identifier may be a laminate, wherein a near field communicator and chip are adhered to a first layer of the laminate and wherein the RFID and antenna are adhered to a second layer of the laminate such that upon delamination the NCF and chip are at least partly separated from the RFID. Therewith functionality of the NFC and chip is maintained when delaminated, allowing identifying of the suitcase and location thereof, whereas the RFID functionality is at least partly lost, identifying an attempt of tampering.

In an exemplary embodiment of the present suitcase locker a second identifier may be provided.

In an exemplary embodiment of the present suitcase locker at least one of a bar code, and two-dimensional code, such as QR-code, is provided.

In an exemplary embodiment of the present suitcase locker the adhesive may be selected from solvent based pressure sensitive adhesives, such as of a dispersion type, contact adhesives, such as a polyurethane contact adhesive, two component adhesives, such as two-part polyurethane or epoxy adhesives, and hot melt adhesives, such as vinyl acetate copolymer adhesives or elastomer adhesives. The present adhesive may be protected by a release-liner. It is noted that for polyolefines such as polyethylene adhesives and solvents are rarely used because polyolefines are typically nonpolar and have a high resistance to solvents. Pressure-sensitive adhesives (PSA), such as a polyurethane contact adhesive, are especially feasible if the surface is flame treated or corona treated. In view of an adhesive applied it is noted that the above treatment also improves the adhesive properties of the present foil significantly, such as with 30-200% relative. In an example the adhesive is applied in an amount of 250-500 g/m², such as 300-400 g/m², in a typical thickness of 0.1-0.5 mm, such as 0.2-0.4 mm, and is applied with a force of 1-2 kg/cm², such as 1.5-1.7 kg/cm². An example thereof is a solvent free synthetic gum, such as BEKO Stripfix®. In view of the digital printing process and sometimes instability of the adhesive under UV the adhesive is applied to the present Suitlocker after printing.

In an exemplary embodiment of the present suitcase locker a strip of adhesive may be provided over a width of the foil, such as a strip of 5-20 mm width, such as 1-15 mm width.

In an exemplary embodiment of the present suitcase locker a second strip of adhesive may be provided for temporarily adhering the foil, wherein the second strip comprises a releasable adhesive.

In an exemplary embodiment of the present suitcase locker a foil part 22 is untreated up to at least 0.5 cm at either longitudinal side thereof, preferably up to at least 1 cm, such as up to at least 2 cm, and wherein adhesive is applied to said untreated part.

In a second aspect the present invention relates to a method of claim 12. By scanning the identifier the unique code may be entered into a database. Therein the unique code may be combined with further information of the owner, such as personal data, as well as travel data.

In an exemplary embodiment of the present method the unique code may be coupled to flight and/or personal data. The scanned identifier code may be coupled to an IMEI number of a smart phone used, and/or the code may be coupled to a SIM number (Phone number) of the phone used. Said personal and flight data may be shared with further parties, such as parties involved in handling the suitcase. Even further by sharing said data an owner and its suitcase is known and as a consequence various handling processes such as on an airport can be performed much quicker. As such a route which a suitcase travels can be secured better and a chance of a suitcase of travelling from its departure to its destination safely in increased.

In an exemplary embodiment of the present method the unique code of the identifier may be entered into a database.

In an exemplary embodiment of the present method a location of the suitcase may be followed over time by wireless determining the location of the identifier. Such determination can be performed on an ad hoc basis, such as when a suitcase needs to be taken apart, or on a scheduled or predetermined basis, such as when passing through various stages of transportation.

In an exemplary embodiment of the present method the suitcase locker may be visually or optically scanned for tampering. Such can be performed on an ad hoc basis, such as when a suitcase needs to be taken apart, or on a scheduled or predetermined basis, such as when passing through various stages of transportation or at the end when the owner receives the suitcase again.

The one or more of the above examples and embodiments may be combined, falling within the scope of the invention.

### FIGURES

FIGS. 1a-h: schematic layout, application and scanning of the present suitlocker 100.

FIGS. 2a-e show the improved opening.

FIG. 3: schematic layout of an exemplary identifier.

FIG. 4: schematic layout of an exemplary identifier.

FIG. 5: flow diagram.

### DETAILED DESCRIPTION OF THE FIGURES

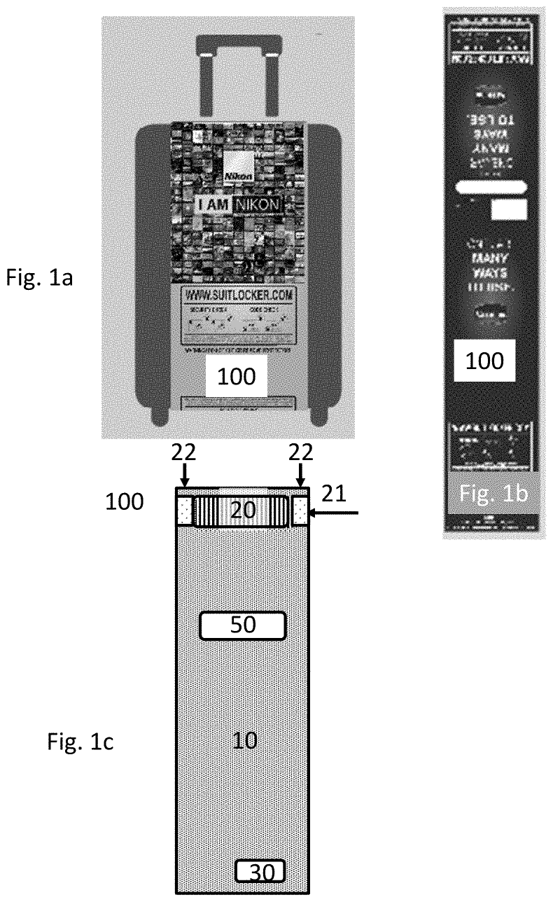

FIGS. 1a-c: schematic layout of the present suitlocker 100. Therein a foil 10, an adhesive 20 provided at a back side thereof, a removable strip 21 on the adhesive, a wireless identifier 30 and an incision 50 are shown. Such a foil may for instance be provided, on demand, by Kivo Plastic Verpakkingen B.V., Volendam, the Netherlands, which foil may be referred to as “Renewable biobased HDPE foil”, which foil comprises 16 wt. % CaO and 1.8 wt. % TiO₂. FIGS. 1d-f show application of the present suitlocker on a suitcase. FIGS. 1g-h show wireless scanning of the present suitlocker.

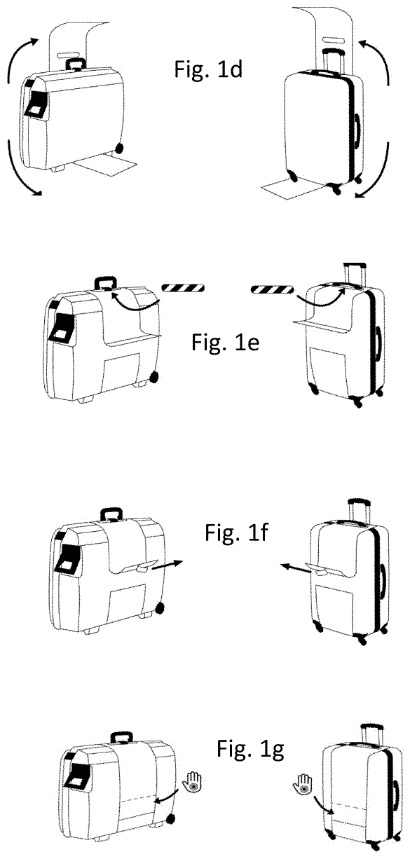

FIG. 2a shows a foil section comprising at least three incision 50, a first horizontal incision 51, adjacent to either end of the horizontal incision two substantially circular incisions 52, wherein the two substantially circular incisions comprise, respectively at an left and right end of the three incisions, an inwardly extending indentation 54, wherein the indentation has at either side two curved sections 55, which curved sections have a smaller radius than the substantially circular incisions, which are further detailed in FIG. 2b shows two incisions at the side. Also intermitted incisions, i.e. integral foil parts, 53 are shown, as well as an adhesive strip 60. Sections inside incisions 52 may be folded away when wrapping the foil around a suitcase. Also incision 51 may be intermitted, typically in the middle thereof. Of course the present opening may be rotated 90 degrees, becoming vertical, in view of other types of suitcases and grips thereof. FIG. 2c shows an example. FIG. 2d shows a complete suitlocker with an openings. FIG. 2e shows two exemplary openings. Therein clearly intermitted sections 53 are shown.

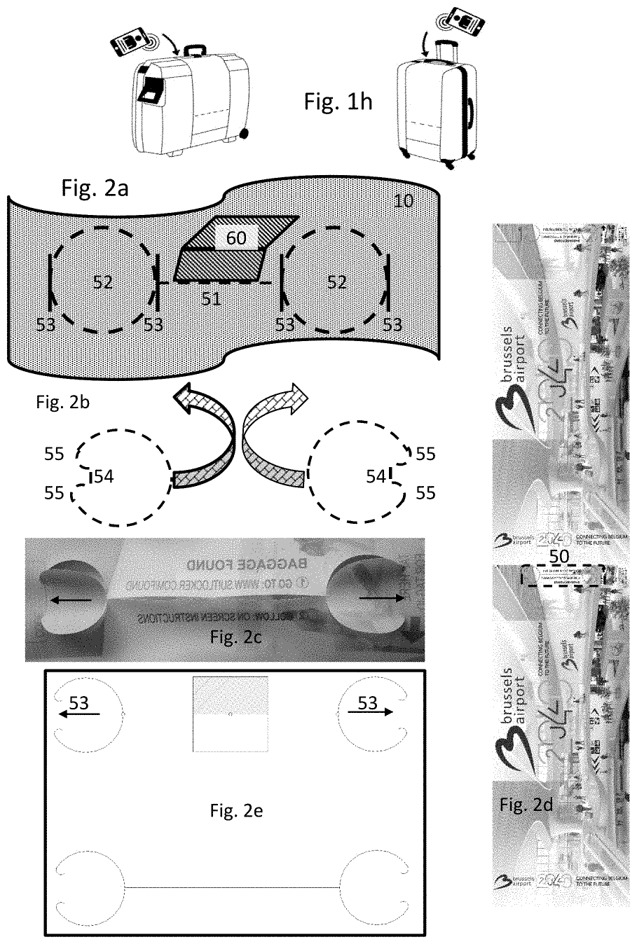

FIG. 3: schematic layout of an exemplary identifier. Therein two layer of a laminate are shown.

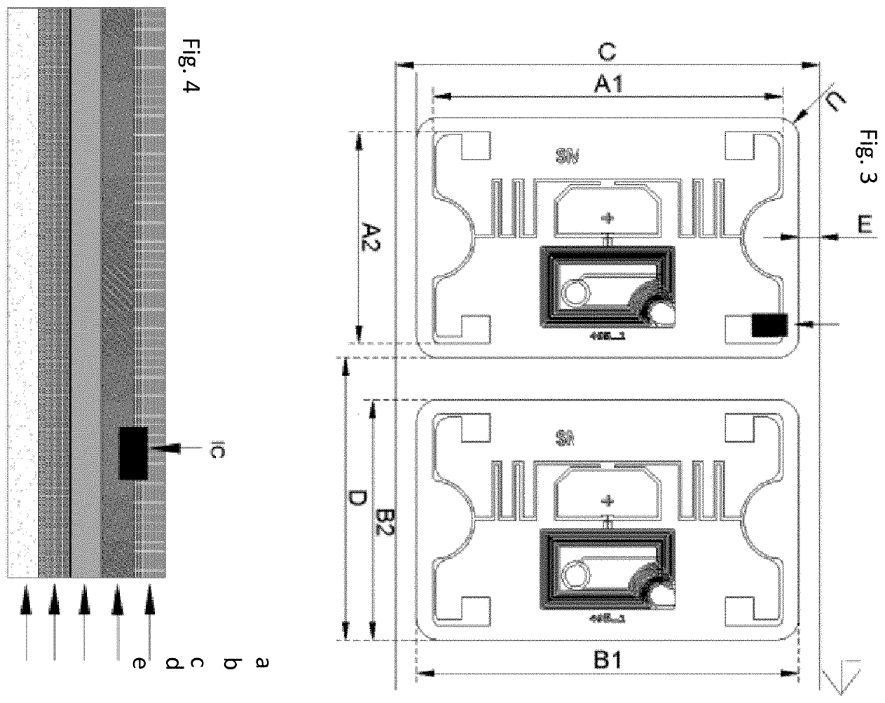

FIG. 4: schematic layout of an exemplary identifier. Therein an IC EM4423 (of EM Microelectronic Marin SA) with a 1920 bit memory, a face material a, an antenna of aluminum b operating at 860-960 MHz, a PET substrate c, an adhesive RA-5 d, and a black paper with silicon liner e are shown.

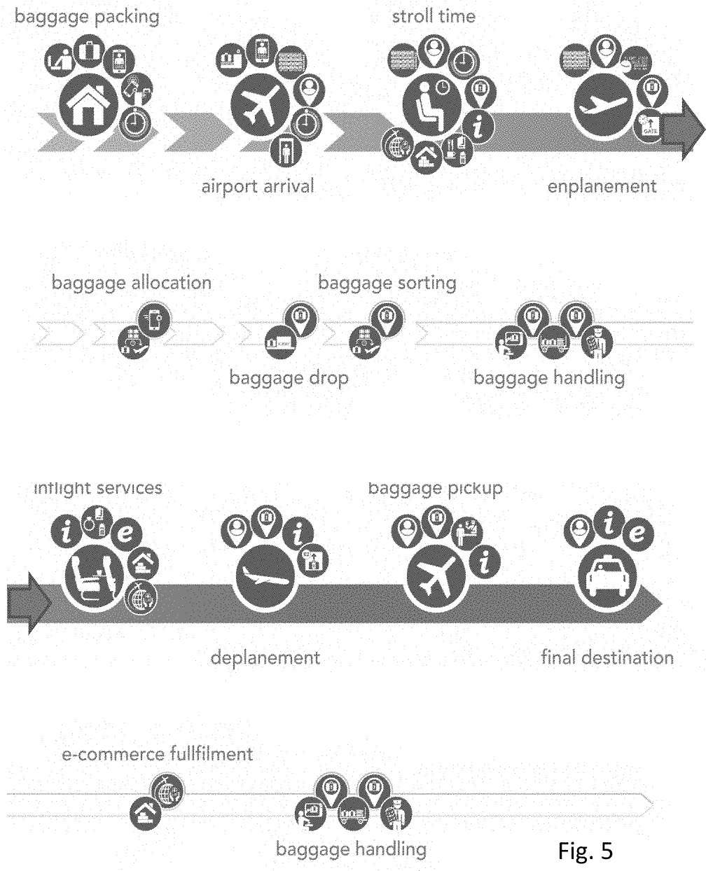

FIG. 5: shows a flow diagram with typical elements when travelling with in this case an airplane.

### Example

The invention is further detailed by the accompanying example, which is exemplary and explanatory of nature and are not limiting the scope of the invention. To the person skilled in the art it may be clear that many variants, being obvious or not, may be conceivable falling within the scope of protection, defined by the present claims.

The table below present typical actions taken on an airport and by a user/traveler. In addition it shows tracking and tracing of the present suitcase and hence functionality of the present suitcase locker.

(table part 1, left part)

| | Location | Event | Action | Function |
|---|---|---|---|---|
| Step 1 | Home | Baggage packing | Apply sleeve | Seal baggage |
| | | | | Increase identification (personal/object) |
| | | | Create personal | |
| | | | account | |
| | | | Fill in Flight Data | Pair Flight Data (E-ticket) |
| | | | Add Sleeve | Add Sleeve ID (NFC serial code) |
| | | | Add extra Sleeves (if | Add extra Sleeves ID (NFC serial code) |
| | | | applicable) | |
| | | | Check-in | Check-in as passenger (PNR) |
| | | | | Measures distance to airport |
| | | | | Calculates time to travel to airport |
| | | | | Shows boarding countdown timer |
| Step 2 | Transit | Travel to airport | Geographical | Measures distance to airport |
| | | | movement | |
| | | | | Calculates time to travel to airport |
| | | | | Shows boarding countdown timer |
| | | | | Show travel status & best travel options |
| Step 3 | Arrival | Arrival at airport | Entering Airport | |
| | | | premises | |
| | | | Start of Suitlocker in- | Measure distance to baggage drop- |
| | | | venue navigation | off/terminal |
| | | | (App) | |
| | | | | Guide to baggage drop-off point |
| | | | Start of airport | Show baggage location (on user |
| | | | baggage tracking | request) |
| | | | (when in use) | |
| | | | | Calculates time to boarding call |
| | | | | Show boarding countdown timer |
| Step 4 | Stroll | Start of Airport | Entering passenger | Calculates time to boarding call |
| | time | Passenger | waiting area | |
| | | Experience | | |
| | | | | Show boarding countdown timer |
| | | | | Show in-app gestures (advertising, duty- |
| | | | | free shopping, food & beverage) |
| Step 5 | Boarding | Start of boarding | Passenger | |
| | | process | enplanement | |
| | | | | Calculates time to boarding call |
| | | | | Show boarding countdown timer |
| | | | Boarding | Show baggage status |
| | | Start of In-Flight | Passenger In-Flight | |
| | | modus | | |
| Step 6 | Destination | Arrival at | Entering Airport | |
| | | destination | premises | |
| | | | Start of Suitlocker in- | Measure distance to baggage carousel |
| | | | venue navigation | |
| | | | (App) | |
| | | | | Guide to baggage carousel |
| | | | Start of airport | Show baggage location (on user |
| | | | baggage tracking | request) |
| | | | (when in use) | |
| Step 7 | Pick-Up | Baggage Pick-Up | Actual baggage Pick- | Allow mobile phone to scan NFC tag |
| | | | Up from carrousel | |
| | | | | Show travel status & best in-venue |
| | | | | navigation options |
| Step 8 | Transit | Travel from | Geographical | Show travel status & best travel options |
| | | airport to final | movement | |
| | | destination | | |

Table part 2 (right part)

| Background Process (Suit- | | | Customs/ | Third | |
|---|---|---|---|---|---|
| locker Database) | Airport | Airline | Security | Party | |
| | | | | | Step 1 |
| Create User Data Record | | | | | |
| (UDR) | | | | | |
| Add Flight Data to UDR | | | | | |
| Add NFC serial code to UDR | | | | | |
| NFC serial code database | | | | | |
| lookup, compare with RFID | | | | | |
| code, add to UDR | | | | | |
| NFC serial code database | | | | | |
| lookup, compare with RFID | | | | | |
| code, add to UDR | | | | | |
| Complete UDR | | | | | |
| Change user status | Send Checked- | Send Checked- | Send Checked- | | |
| | In status to | In status to | In status | | |
| | Airport | Airline | | | |
| Change NFC/RFID tag status | Send baggage | Send baggage | Send baggage | | |
| | status to | status to | status | | |
| | Airport | Airline | | | |
| | Send baggage | Send baggage | Send baggage | | |
| | data to Airport | data to Airline | data | | |
| Monitor actual Flight Data | | | | | |
| events/changes | | | | | |
| Monitor traffic | | | | | |
| events/changes | | | | | |
| Monitor actual Flight Data | | | | | Step 2 |
| events/changes | | | | | |
| Monitor traffic | | | | | |
| events/changes | | | | | |
| Calculate best travel options | | | | | |
| | | | | | Step 3 |
| Monitor actual Flight Data | | | | | |
| events/changes | | | | | |
| Record baggage drop-off | Send baggage | Send baggage | Send baggage | | |
| | drop status to | drop status to | drop status | | |
| | Airport | Airline | | | |
| Compare boarding data, | | | | Open | |
| personal data & baggage data | | | | passenger | |
| | | | | profile for | |
| | | | | LBS/LBM | |
| Start baggage tracking | (Retrieve | (Retrieve | (Retrieve | | |
| | baggage status) | baggage status) | baggage status) | | |
| Monitor actual Flight Data | | | | | |
| events/changes | | | | | |
| Monitor boarding | | | | | Step 4 |
| events/changes | | | | | |
| Monitor actual Flight Data | | | | | |
| events/changes | | | | | |
| Calculate best boarding gate | | | | | Step 5 |
| navigation options | | | | | |
| Compare boarding data, | | | | | |
| personal data & actual | | | | | |
| in-venue location | | | | | |
| Monitor actual Flight Data | | | | | |
| events/changes | | | | | |
| Monitor boarding | | | | | |
| events/changes | | | | | |
| Change to In-Flight modus | Compare | Compare | Changes | Change | |
| | passenger status | passenger status | passenger status | passenger | |
| | with boarding | with boarding | & boarding list | profile for | |
| | list | list | | IFE | |
| Change to destination modus | | | | | Step 6 |
| Monitor actual baggage | | | | | |
| events/changes | | | | | |
| Record baggage unloading | Send baggage | Send baggage | Send baggage | | |
| | status to | status to | status | | |
| | Airport | Airline | | | |
| Compare boarding data, | | | | Open | |
| personal data & baggage data | | | | passenger | |
| | | | | profile for | |
| | | | | LBS/LBM | |
| Start baggage tracking | (Retrieve | (Retrieve | (Retrieve | | |
| | baggage status) | baggage status) | baggage status) | | |
| Monitor actual baggage | | | | | |
| events/changes | | | | | |
| Compare boarding data, | | | | | Step 7 |
| personal data & baggage data | | | | | |
| Record baggage Pick-Up | Record | Record | Record | | |
| (RFID scan leaving baggage | baggage Pick-Up | baggage Pick-Up | baggage Pick-Up | | |
| area towards customs/exit) | | | | | |
| | | | | Change | |
| | | | | passenger | |
| | | | | profile for | |
| | | | | LBS/LBM | |
| Open to connect-to/retrieve | Send Checked- | Send Checked- | Send Checked- | Change | Step 8 |
| 3rd party data/software | Out status to | Out status to | Out status | passenger | |
| | Airport | Airline | | profile for | |
| | | | | LBS/LBM | |

1. Flexible suitcase locker (100) comprising
a printable foil (10),
wherein the foil (10) has a thickness of 40-200 μm,
wherein the foil (10) comprises at least one polymer wherein all wt. % are based on a total weight of the foil,
wherein at at least one longitudinal end thereof the foil is provided with an adhesive (20), which adhesive upon application provides a bond between two ends, which adhesive upon application provides a bond between two ends that has a direct adhesive strength of >20 N/cm² (ISO 8510-2:2006), and a removable strip (21) covering said adhesive,
characterized in that
the foil (10) comprises at least one opening (50) providing space for a suitcase handle, the opening comprising at least three incisions, a first horizontal incision (51), adjacent to either end of the horizontal incision two substantially circular incisions (52), wherein the two substantially circular incisions comprise, respectively at an left and right end of the three incisions, an inwardly extending indentation (54), wherein the indentation has at either side two curved sections (55), which curved sections have a smaller radius than the substantially circular incisions,
the foil (10) has a width of 10-50 cm, a length of 150-200 cm,
the foil (10) is tamperproof,
the foil (10) is digitally printable,
the foil (10) comprises 10-50 wt. % inorganic filler,
the foil (10) has an ultimate tensile strength (ISO 1184, 25° C.) of 5-100 MPa,
the foil (10) has a Youngs modulus of <2.5 GPa,
the foil (10) has an elongation (ISO 1184) at break of >50%,
the foil (10) has a coefficient of friction (film to film, untreated side to untreated side; ISO 8295) of 0.2-0.4 (dynamic), and
the bond cannot be broken without deforming the foil.

2. Suitcase locker according to claim 1, wherein the three incisions form one combined incision, or wherein at least one incision is intermitted such that the foil apart from the incisions is integral (53).

3. Suitcase locker according to claim 1, comprising an adhesive strip (60) located adjacent to incision (51) for securing the foil around a grip.

4. Suitcase locker according to claim 1, wherein the adhesive (20) is a pressure sensitive adhesive, which adhesive upon application provides a bond between two ends that has a direct adhesive strength of >25 N/cm² (ISO 8510-2:2006), and wherein the foil comprises pores and/or comprises pores after treatment, wherein pores are in a size range of 100-2500 nm.

5. Suitcase locker according to claim 1, wherein the foil has at least one of
an ultimate tensile strength (ISO 1184, 25° C.) of 7-75 MPa,
a Youngs modulus of <2.0 GPa,
an elongation (ISO 1184) at break of >100%,
a density of 1-1.2 g/cm³, and
a coefficient of friction (film to film, un-treated side to untreated side; ISO 8295) of 0.25-0.35, and 0.3-0.5 (static).

6. Suitcase locker according to claim 1, wherein the foil has a glass transition temperature of <60° C. (ISO 11357-2:2013).

7. Suitcase locker according to claim 1, wherein the foil has a melt temperature of >70° C. (ISO 3146:2000).

8. Suitcase locker according to claim 1, wherein the inorganic filler is selected from calcium oxide, calcium carbonate, clays, silica-alumina clays, silica, talc, chalk, titanium oxide, and combinations thereof.

9. Suitcase locker according to claim 1, wherein the polymer is selected from polyolefines, polypropylene, polyethylene, high density PP and PE, biodegradable polymers, biobased polymers, and combinations thereof.

10. Suitcase locker according to claim 1, comprising an identifier (30) which is a laminate, wherein a near field communicator and chip are adhered to a first layer of the laminate and wherein the RFID and antenna are adhered to a second layer of the laminate such that upon delamination the NCF and chip are at least partly separated from the RFID.

11. Suitcase locker according to claim 10, wherein the identifier is adapted to provide wireless communication selected from at least one of radio frequency (RF), near field (NF), and near infra-red.

12. Suitcase locker according to claim 1, wherein the foil comprises pores and comprises pores after treatment, wherein the adhesive is selected from solvent based pressure sensitive adhesives, contact adhesives, two component adhesives, and hot melt adhesives.

13. Suitcase locker according to claim 1, wherein a foil part (22) is untreated up to at least 0.5 cm at either longitudinal side thereof, and wherein adhesive is applied to said untreated part.

14. Method of tracking, comprising
providing a suitcase,
applying the suitcase locker to the suitcase by wrapping the locker around the suitcase and adhering the two ends to one and another,
characterized in that
a suitcase locker according to claim 1 is provided, wherein
the foil has a width of 15-50 cm, a length of 150-200 cm,
the foil is tamperproof,
the foil is digitally printable,
the foil comprises 10-50 wt. % inorganic filler, and
the bond cannot be broken without deforming the foil,
and optionally scanning the identifier therewith providing a unique code, at a distance of 0.1-500 cm.

15. Method according to claim 14, wherein the unique code is coupled to at least one of flight and personal data.

16. Method according to claim 14, wherein the unique code of the identifier is entered into a database.

17. Method according to claim 14, wherein a location of the suitcase is followed over time by wireless determining the location of the identifier.

18. Method according to claim 14, wherein the suitcase locker is visually or optically scanned for tampering.

19. Opening (50) for use in a Suitlocker comprising at least three incisions, a first horizontal incision (51), adjacent to either end of the horizontal incision two substantially circular incisions (52), wherein the two substantially circular incisions comprise, respectively at an left and right end of the three incisions, an inwardly extending indentation (54), wherein the indentation has at either side two curved sections (55), which curved sections have a smaller radius than the substantially circular incisions.
